(19) United States
(12) Patent Application Publication
(10) Pub. No.: US 2014/0357425 A1
(43) Pub. Date: Dec. 4, 2014

(54) GOLF BALL WITH VISIBLE LIGHT-CURED COATING AND METHOD

(71) Applicant: NIKE, Inc., Beaverton, OR (US)

(72) Inventors: Eric Coats, Forest Grove, OR (US); Thomas J. Kennedy, III, Wilbraham, MA (US)

(21) Appl. No.: 13/906,782

(22) Filed: May 31, 2013

(51) Int. Cl. A63B 37/00; B05D 7/00; A63B 45/00; B05D 3/06

(52) U.S. Cl. CPC A63B 37/0022; B05D 3/06; B05D 7/536; A63B 45/00
USPC 473/378; 427/553

(57) ABSTRACT

A golf ball or other article of sports equipment is coated with a clear coating including a free radical-curable material and a photoinitiator that absorbs light in the visible light region of the electromagnetic spectrum to generate free radicals. The coating is cured with radiation in the visible light region of the electromagnetic spectrum. An indicium may be printed on the uncoated ball with a free radical-curable material and a photoinitiator that absorbs light in the visible light region and may, if not completely cured when the coating is applied, be further cured along with the applied clear coating layer.

### BACKGROUND

The present disclosure generally relates to clear coatings for golf balls or other articles and to methods for making such coatings.

Coatings curable with ultraviolet light (“UV”) have been used for forming thermoset finishes on various articles. Typical UV-curable coatings comprise acrylate- or methacrylate-functional resins, oligomers, and monomers along with a photoinitiator component that absorbs in the ultraviolet region of light. Curing with UV light is a less than satisfactory process in that the cost of bulbs for generating ultraviolet radiation is high and their operation is energy-intensive. Further, they typically generate ozone, which presents a potential regulatory issue, and the UV radiation itself could be a safety concern.

### SUMMARY

This section provides a general summary and not necessarily a comprehensive disclosure of the invention and all of its features.

A game ball, such as a golf ball, or other article of sports equipment is coated with a clear coating including a free radical-curable material and a photoinitiator that absorbs light in the visible light region of the electromagnetic spectrum to generate free radicals, then the applied coating layer is cured by exposure to visible light at a wavelength that is absorbed by the photoinitiator. A free radical-curable material is one for which cure (by addition polymerization of the material) is initiated by free radicals.

In one embodiment the photoinitiator that absorbs light in the visible light region is one that has little or no color in the cured film or that oxidizes to an oxidation state that is colorless or has a less intense color compared to its state before or during the coating curing process. In another embodiment the coating is cured with visible light radiation from an LED (light-emitting diode). In yet another embodiment the coating is cured with a photoinitiator selected from Type I photoinitiators and Type II photoinitiator compounds containing abstractable hydrogens, particularly those having low color in the cured coating. In still another embodiment the coating is cured with a Type II photoinitiator compound and the coating free radical-curable material containing abstractable hydrogens. In particular embodiments, these coatings with Type II photoinitiators are free from amine compounds.

Further disclosed is a method and resulting article for first printing a game ball, such as a golf ball, or other article of sports equipment with an indicium by an ink cured using a photoinitiator that absorbs in the visible light region of the electromagnetic spectrum, then coating the game ball or other article of sports equipment with the clear visible light-curable coating as described at least in an area over the printed indicium. The coating is cured by exposure to visible light at a wavelength that is absorbed by the photoinitiator of the coating to generate free radicals. The ink may be applied by any appropriate printing method, for example by pad transfer printing. The ink includes a free radical-curable material that may be the same or different from the free radical-curable material of the coating, a photoinitiator that may be the same or different from the photoinitiator of the coating, and a colorant. The ink is at least partially cured by exposure to intense visible light at a wavelength that is absorbed by the photoinitiator in the ink before the golf ball is coated with the clear coating. Preferably, the photoinitiator is oxidized after the coating is cured to a lower-color or colorless oxidation state.

In one embodiment, the ink and the coating contain the same photoinitiator used in curing the applied coating layer so that the ink is cured further when the coating is cured by exposure to visible light at a wavelength that is absorbed by the photoinitiator to generate free radicals the initiate polymerization of the free radical-curable material in the coating. In another embodiment, the ink contains an initiator that is different from the initiator in the coating but that absorbs visible light at a wavelength that is in the visible light emitted by the light source used to cure the coating so that the ink is cured further when the coating is cured. In still another embodiment, the ink contains an initiator that is different from the initiator in the coating and two light sources are used during curing of the coating, one that emits visible light at a wavelength that is absorbed by the coating's photoinitiator to generate free radicals and cure the coating and a second light source that emits visible light at a wavelength that is absorbed by the ink's photoinitiator to generate free radicals and further cure the ink. In each case, the coating photoinitiator may be one that is oxidized after the coating is cured to a low-color or colorless oxidation state.

Coating golf balls with a visible light-curing coating offers several advantages over other coatings. As compared to heat-cured coatings, the visible light cured coating cures more quickly and with less consumption of energy and typically no regulated emissions. As compared with coatings that are cured with UV light, the visible light cured coating creates no ozone or appreciable heat that must be removed from the workplace. Further, the UV light itself is intense and is subject to regulation in the workplace, including shields to ensure that the UV irradiation does not cause injury. Also, it is periodically necessary to check the strength and wavelength of UV irradiation by passing a calibration-checking device through the UV irradiation, thus disrupting production. As the UV lamp ages, it becomes necessary to adjust the curing process to change in the strength or wavelength from the lamp. UV bulbs often need replacement. In contradistinction, visible light generated from diodes seldom needs calibration, does not produce as much heat, and does not generate ozone. Additionally, the diodes have a long service life.

“Indicium” refers to a printed number, mark, design, image, character, text, graphic, pattern, or any combinations of these, which may be monochromatic, polychromatic, black and white, or full-color. “(Meth)acrylic” is used as an abbreviation for “methacrylic or acrylic”; correspondingly, “(meth)acrylate” is used as an abbreviation for “methacrylate or acrylate,” “(meth)acrylated” is used as an abbreviation for “methacrylated or acrylated,” and “poly(meth)acrylate” is used as an abbreviation for “polymethacrylate or polyacrylate.”

The method used for measuring coating viscosity may be selected according to the type of application method used. One such method for measuring viscosity of coatings applied by spray application is according to ASTM D4212 using a Zahn #2 cup.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiment. As used in this specification, the term “or” includes any and all combinations of one or more of the listed items.

### BRIEF DESCRIPTION OF THE DRAWINGS

The drawings illustrate some aspects of the disclosed technology. The components in the figures are not necessarily to scale, emphasis instead being placed upon illustrating the principles of the invention. Like reference numerals designate corresponding parts throughout the different views.

FIG. 1 illustrates a cut-away view of a golf ball having a clear top coat over an ink indicium cured with visible light according to disclosed embodiments;

FIG. 2 is a view of the surface of a golf ball having a clear top coat over an ink indicium cured with visible light according to disclosed embodiments;

FIG. 3 is a schematic diagram of a first process part according to an embodiment of the disclosed technology; and

FIG. 4 is a schematic diagram of a second process part according to an embodiment of the disclosed technology

### DETAILED DESCRIPTION

A detailed description of exemplary, nonlimiting embodiments follows.

A game ball, such as a golf ball, or other article of sports equipment is coated with a clear coating including a free radical-curable material and a photoinitiator that absorbs light in the visible light region of the electromagnetic spectrum to generate free radicals. The photoinitiating compounds may also absorb light at ultraviolet wavelengths, but the coating is cured with radiation at one or more visible light wavelengths. The coatings may preferably be formulated to have good impact resistance, adhesion, and durability, making them suitable for use on items in rough service, such as game balls and other articles of sports equipment that are subjected to repeated impacts during play. In various embodiments, the coating is applied onto a game ball, and particularly on a golf ball, and cured with radiation at one or more visible light wavelengths, such as at one or more wavelengths in the region of from about 400 nm to about 690 nm.

The free radical-curable material of the coating composition typically includes a resin having a plurality of free radical-curable groups. The term “resin” as used includes both polymers and oligomers. Suitable free radical-curable groups include various ethylenically unsaturated groups, for example (meth)acrylate groups, ethacrylate groups, crotonate groups, vinyl ether groups, vinyl ester groups, and allyl groups such as allyl ether groups and allyl ester groups. Nonlimiting examples of suitable resins include (meth)acrylate-functional acrylic or vinyl copolymers, polyether(meth)acrylates, epoxy(meth)acrylates, urethane(meth)acrylates, elastomeric(meth)acrylates such as (meth)acrylated polyester- and polyether-based polyurethanes, unsaturated polyesters including (meth)acrylated polyesters and polyesters prepared with unsaturated monomers such as maleic anhydride or fumaric acid, dendritic(meth)acrylates, and the corresponding vinyl ethers and vinyl esters of these (meth)acrylate resins.

Examples of suitable resins having a plurality of free radical-curable groups include poly(meth)acrylates and allyl esters such as (meth)acrylated carboxyl- or hydroxyl-functional polyesters, hydroxyl- or isocyanate-functional polyurethanes, particularly polyester-polyurethanes, polyether-polyurethanes, and polycarbonate-polyurethanes, and carboxyl-, epoxide-, hydroxyl-, or isocyanate-functional vinyl copolymers, particularly acrylic copolymers, as well as allyl esters of such carboxyl- or epoxide-functional resins.

Suitable polyesters may be prepared by the condensation polymerization of polyacid compounds and polyol compounds. Preferably, the polyacid compounds and polyol compounds are difunctional, i.e., diacid compounds and diols are used to prepare linear polyester diols, although small amounts of mono-functional, tri-functional, or higher functionality materials can be included to provide a slightly branched polyester. The polyacids may be used as their anhydride or esterifiable ester (particularly methyl ester) derivatives. Suitable dicarboxylic acid reactants include, without limitation, glutaric acid, succinic acid, malonic acid, oxalic acid, phthalic acid, isophthalic acid, terephthalic acid, hexahydrophthalic acid, adipic acid, maleic acid, anhydrides of these, methyl esters of these, and combinations of these. Suitable diols include, without limitation, ethylene glycol, diethylene glycol, triethylene glycol, tetraethylene glycol, propylene glycol, dipropylene glycol, tripropylene glycol, tetrapropylene glycol, cyclohexanedimethanol, 2-ethyl-1,6-hexanediol, 1,4-butanediol, 1,5-pentanediol, 1,3-propanediol, butylene glycol, neopentyl glycol, and combinations of these. As mentioned, small amounts of triols or higher functionality polyols, such as trimethylolpropane or pentaerythritol, may sometimes be included. Typical catalysts for the esterification polymerization may be used, such as protonic acids, Lewis acids, titanium alkoxides, and dialkyltin oxides. An equivalent excess of polyacid compounds results in a carboxyl-functional polyester; and equivalent excess of polyol compounds results in a hydroxyl-functional polyester.

The hydroxyl-functional polyesters can be provided with ethylenic unsaturation by reaction with a diisocyanate and an ethylenically unsaturated alcohol such as a hydroxyalkyl(meth)acrylate or allyl alcohol. Nonlimiting, suitable examples of diisocyanates that may be used include isophorone diisocyanate, tetramethylxylylene diisocyanate, hexamethylene diisocyanate, trimethylhexamethylene diisocyanate, 4,4′-diisocyanatodicyclohexylmethane, 4,4′-diisocyanatodiphenylmethane, 2,4-diisocyanatodiphenylmethane (generally in admixture with the 4,4′-diisocyanatodiphenylmethane isomer), and tolylene diisocyanate. Nonlimiting, suitable examples of the hydroxyalkyl(meth)acrylates that may be used include hydroxyethyl(meth)acrylate, 2- or 3-hydroxypropyl(meth)acrylate, and 2-, 3- and 4-hydroxybutyl(meth)acrylate. The carboxyl-functional polyesters can be provided with ethylenic unsaturation by reaction with a compound having an ethylenically unsaturated group and an epoxy functional group. Nonlimiting, suitable examples of compounds having an ethylenically unsaturated group and an epoxy functional group are glycidyl acrylate, glycidyl methacrylate, methyl glycidyl methacrylate, methyl glycidyl acrylate, 3,4-epoxycyclohexylmethyl(meth)acrylate, 1,2-ethyleneglycolglycidylether(meth)acrylate, 1,3-propyleneglycolglycidylether(meth)acrylate, 1,4-butyleneglycolether(meth)acrylate, 1,6-hexanediolether(meth)acrylate, and allyl glycidyl ether.

Polyesters can also be provided with ethylenic unsaturation by copolymerization of a monomer having an ethylenically unsaturated group. Among such ethylenically unsaturated monomers that may be used are trimethylolpropane monoallyl ether, 1,3-propanediol, 2-(2-propen-1-yl)-2-[(2-propen-1-yloxy)methyl]; 1,3-propanediol, 2-methyl-2-[(2-propen-1-yloxy)methyl]; 1,3-propanediol, 2,2-bis[(2-propen-1-yloxy)methyl; 1,3-propanediol, 2-[(2,3-dibromopropoxy)methyl]-2-[(2-propen-1-yloxy)methyl]; maleic anhydride; itaconic anhydride; and fumaric acid.

Hydroxyl- or isocyanate-functional polyurethanes are the polymerization products of one or more diisocyanates and one or more diols, such as any of those already mentioned. In certain preferred embodiments, the polyurethane is a polyester-polyurethane, polyether-polyurethane, or polycarbonate-polyurethane prepared by co-polymerizing a polyester diol, polyether diol, or polycarbonate diol, the polymeric diols generally having a number average molecular weight of from about 500 and to about 4,000. The polyester diol may be any of those already described. Polylactone polyesters may also be mentioned as suitable and are prepared by reacting a diol initiator, e.g., ethylene or propylene glycol, with a lactone such as ε-caprolactone, γ-caprolactone, β-butyrolactone, β-propriolactone, γ-butyrolactone, α-methyl-γ-butyrolactone, β-methyl-γ-butyrolactone, γ-valerolactone, δ-valerolactone, γ-decanolactone, δ-decanolactone, γ-nonanoic lactone, γ-octanoic lactone, and combinations of these. In one preferred embodiment, the lactone is ε-caprolactone. Nonlimiting, suitable examples of polyether polyols are polyoxyethylene glycol, polyoxypropylene glycol, polyoxybutylene glycol, polytetramethylene glycol, block copolymer ethers such as those prepared by sequential addition of two or more alkylene oxides. Nonlimiting, suitable examples of polycarbonate diols are those prepared by the reaction of diols with dialkyl carbonates (such as diethyl carbonate), diphenyl carbonate, or dioxolanones (such as cyclic carbonates having five- and six-member rings) in the presence of catalysts like alkali metal, tin catalysts, or titanium compounds. Useful diols include, without limitation, any of those already mentioned. Aromatic polycarbonates are usually prepared from reaction of bisphenols, e.g., bisphenol A, with phosgene or diphenyl carbonate.

Hydroxyl-functional polyurethanes may be provided with ethylenic unsaturation in the same manner as described for the hydroxyl-functional polyesters. Isocyanate-functional polyurethanes may be provided with ethylenic unsaturation by reaction with an ethylenically unsaturated alcohol, such as any of those already mentioned, or by reaction with an ethylenically unsaturated secondary amine, such as t-butylaminoethyl(meth)acrylate or N,N-diallylamine.

Carboxyl-, epoxide-, hydroxyl-, or isocyanate-functional vinyl copolymers such as acrylic polymers may be prepared by copolymerizing a monomer having the functionality selected from carboxyl groups, epoxide groups, hydroxyl groups, and isocyanate groups, such as the unsaturated epoxide and hydroxy monomers already mentioned, (meth)acrylic acid, crotonic acid, etharylic acid, isocyanatoethyl methacrylate, and α,α-dimethyl meta-isopropenyl benzyl isocyanate to mention some common such monomers, along with one or more desired comonomers. Suitable comonomers include esters, nitriles, and amides of acrylic acid, methacrylic acid, and crotonic acid; vinyl esters, vinyl ethers, vinyl ketones, vinyl amides, and aromatic and cycloaliphatic vinyl compounds. Specific examples include methyl, ethyl, propyl, butyl, 2-ethylhexyl, isobutyl, isopropyl, and cyclohexyl(meth)acrylate, isobornyl acrylate, dimethyl maleate; vinyl acetate, vinyl propionate, vinyl ethyl ether, and vinyl ethyl ketone; styrene, α-methyl styrene, vinyl toluene, 2-vinyl pyrrolidone, p-tert-butylstyrene, and 1,6-hexanediol diacrylate (HDODA). The co-monomers may be used in any desired combination to obtain desired coating properties. The hydroxyl, carboxyl, and isocyanate groups may be reacted with ethylenically unsaturated compounds as already described to provide ethylenic unsaturation to the vinyl copolymer. Epoxide groups may be reacted with an unsaturated carboxylic acid, for example (meth)acrylic acid, crotonic acid, etharylic acid, or a monoester of maleic acid, maleic anhydride, or itaconic acid to introduce the ethylenic unsaturation.

The resin having a plurality of free radical-curable groups may be of any suitable molecular weight for the selected method of applying the coating. The number average molecular weight may desirably range from about 500 to about 10,000, preferably from about 1,000 to about 8,000, more preferably from about 1,000 to about 5,000, and most preferably from about 1,200 to about 3,000. Blends of different resins can be used. The resin typically is present to provide the coating with properties and characteristics such as flexibility and impact resistance, sufficient to withstand the conditions to which the coated game ball or other sports article will be subjected. The resin may also have one or more functional groups that promote adhesion to the substrate, such as acid groups.

Other examples of resins having a plurality of free radical-curable groups include any of the reaction products of ethylenically unsaturated alcohols such as hydroxyalkyl(meth)acrylates and allyl alcohol with oligomers of hexamethylene diisocyanate, isophorone diisocyanate, or other diisocyanates, the isocyanate-functional reaction products of polyols such as polyethylene glycol, polypropylene glycol, glycerol, or trimethylolpropane and their ethoxylated, propoxylated and polycaprolactone analogs with diisocyanates such as hexamethylene diisocyanate or isophorone diisocyanate, and the like.

Suitable free radical-curable resins are also commercially available, for example from Cytec Industries (Woodland Park, N.J.) under the trademark EBECRYL® and UCECOAT®, from Sartomer USA LLC (Exton, Pa.), from Bayer Material Science Corporation (Pittsburgh, Pa.) under the trademark Desmolux®, and from BASF Corporation (Wyandotte, Mich.) under the trademark Laromer®.

The free radical-curable material may typically include from about 30 wt percent to 100 wt percent of the resin having a plurality of free radical-curable groups. In various embodiments, the free radical-curable material contains from about 40 wt % or from about 50 wt % or from about 60 wt % or from about 70 wt % to about 75 wt % or to about 80 wt % or to about 90 wt % or to about 99 wt % or to 100 wt % of the resin having a plurality of free radical-curable groups. Among typical ranges that may be selected from those disclosed here are from about 50 wt % and 100 wt % and from about 70 wt % and about 100 wt % of the resin having a plurality of free radical-curable groups based on the total weight of free radical-curable material in the coating composition applied in making a clear top coat layer.

The balance of free radical-curable material that is not a resin is one or more ethylenically unsaturated monomers. A free radical-curable monomer can be, for example, a monofunctional, difunctional, or multifunctional (meth)acrylate, vinyl ester, or vinyl ether. Nonlimiting examples of suitable monomers include mono(meth)acrylate monomers such as stearyl(meth)acrylate, tetrahydrofurfuryl(meth)acrylate, isobornyl(meth)acrylate, 2-tert-butyl cyclohexyl(meth)acrylate, 4-tert-butyl cyclohexyl(meth)acrylate, and isodecyl(meth)acrylate; poly(meth)acrylates such as 1,6-hexanediol di(meth)acrylate, butanediol di(meth)acrylate, tripropylene glycol di(meth)acrylate, tetraethylene glycol di(meth)acrylate, ethylene glycol di(meth)acrylate, diethyleneglycol di(meth)acrylate, trimethylolpropane mono-, di- or tri(meth)acrylates, pentaerythritol mono-, di-, tri- or tetra(meth)acrylates, and 2,2-bis-4-(2-hydroxy-3-methacryloyloxy)phenylpropane; and vinyl monomers such as styrene, vinyl ethers such as butyl vinyl ether, and vinyl esters such as vinyl acetate.

Embodiments of the coating composition may typically contain between about 1 wt percent to about 60 wt percent monomer, more typically between about 10 wt percent and about 50 wt percent monomer, and most typically between about 10 wt percent and about 30 wt percent monomer, based on the total weight of free radical-curable materials in the coating composition, depending on the method of application for which the coating is formulated.

Coating compositions containing aliphatic urethane acrylates are preferred in various embodiments, particularly when toughness, abrasion resistance, and lightfastness are desired. These may be used with, for example, isobornyl(meth)acrylate and 1,6-hexanediol diacrylate (HDODA) as monomers.

The coating further includes a photoinitiating component that is selected from compounds that absorb radiation in the visible light region of the electromagnetic spectrum to generate free radicals. There are two types of visible light-active photoinitiators, Norrish Type I (“α-cleavage”) photoinitiators and Norrish Type II (“hydrogen-abstraction”) photoinitiators. In various embodiments, the photoinitiator that absorbs light in the visible light region is one that has little or no color in the cured film or that oxidizes to an oxidation state that is colorless or has a less intense color compared to its state before the coating is cured, preferably a 4 or lower on the Gardner liquid color scale (according to ASTM D1544). Suitable examples of such photoinitiators are bis(2,4,6-trimethylbenzoyl)phenylphosphine oxide (TPO), mono- and di-benzoyl germane compounds such as benzoyltrimethylgermane, dibenzoyldiethylgermane and bis-germyl ketones, bis(2,6-dichlorobenzoyl)-(4-propylphenyl)phosphine oxide (Irgacure 819), 1-phenyl-1,2-propanedione, and di-2,3-diketo-1,7,7-trimethylnorcamphane. For photoinitiators that oxidize to a lower color after the coating is cured, such as the titanium, germane, and the other photoinitiators just mentioned, oxygen is preferably excluded from the resin system during curing. An example of reduced color after photoinitiation is camphorquinone, which has a peak absorbance at about 470 nm, and which will reduce in yellow color after photoinitiation.

Type II photoinitiators that oxidize after curing the coating may be selected from bis(η5-2,4-cyclopentadien-1-yl) bis[2,6-difluoro-3-(1H-pyrrol-1-yl)phenyl]-titanium, 5,7-diiodo-3-butoxy-6-fluorone, 2,4,5,7-tetraiodo-3-hydroxy-6-fluorone, and 2,4,5,7-tetraiodo-3-hydroxy-9-cyano-6-fluorone.

Type II initiators require a hydrogen donor. To make a low color or colorless top coat, the hydrogen donor is selected to be colorless or low color. For example, aliphatic secondary or tertiary alcohols, aliphatic ethers, and aliphatic amines may be used as hydrogen donors. A separate “co-initiator” is not needed if a component of the free radical-curable material can provide a hydrogen, for example because it contains an amine group, as does 2-(N,N-dimethylamino)ethyl methacrylate, or an allylic hydrogen. Suitable examples of free radical-curable materials having allylic hydrogens or include allyl monomers, of which allyl methacrylate and diallyl ether may particularly be mentioned. A number of suitable examples of such free radical-curable materials are described in Blum et al, U.S. Pat. No. 6,133,337. Generally, the hydrogen donor compound may be included in amounts of up to about 10 wt % based on the total weight of the Type II initiator.

A “co-initiator” is not necessary when sufficient hydrogen abstraction may be obtained from a group of the visible light Type II photoinitiator itself. Eliminating the co-initiator not only saves formulation cost but also may allow the ink to have better color when cured because the amines commonly used to supply abstractable hydrogens are not needed. Examples of Type II photoinitiators that may be used without a “co-initiator” to supply abstractable hydrogens include 2-mercaptothiosanthone (TX-SH) and 9-(2-morpholine-4-yl-acetyl)-5-thia-naphthasen-12-one (TXMPM). A TX-based photoinitiator having an anthracene group, 5-thia-pentacene-14-one also does not require an additional hydrogen donor for free radical formation.

Blends of different photoinitiators can be used. The coating composition typically contains from about 0.5 wt percent to about 15 wt percent photoinitiator, or from about 3 wt percent and about 13 wt percent, or from about 5 wt percent to about 12 weight percent photoinitiator based on the total weight of free radical-curable materials in the coating composition. The amount of photoinitiator component used in relation to the amount of free radical-curable materials in the coating depends upon the particular photoinitiator or photoinitiators used as well as the particular free radical-curable materials used and the desired rate of cure, and the amounts may be optimized in a straightforward manner to suit the particular use. Type I photoinitiators are typically used in higher amounts than are Type II photoinitiators. Type II photoinitiators are typically used in amounts of from about 0.5 wt % to about 7 wt. % based on the amount of free radical-curable material.

The coating may also contain one or more customary additives such as dispersants, hindered amine light stabilizers such as piperidines and oxanalides, ultraviolet light absorbers such as benzotriazoles, triazines, and hindered phenols, antioxidants such as phenols, phosphites, and hydrazides, plasticizers, defoaming agents, processing aids, surfactants, and so on. Generally, the additives will be present in the composition in an amount of up to about 10 weight percent based on the total weight of the composition depending upon the desired properties.

The coating composition can be applied to the golf ball or other game ball or article of sports equipment by various methods, such as by spraying, brushing, dipping, rolling, roller coating, or flow coating. The coating formulation can be adjusted for the application method, for example so that the coating has an appropriate viscosity. Organic solvents, water, or ethylenically unsaturated monomer (particularly monoethylenically unsaturated monomers, but also polyethylenically unsaturated monomers) can be used to adjust the coating to a desired application viscosity. When the coating is applied by spraying the viscosity may be from about 15 to about 25 seconds measured with a Zahn #2 cup according to ASTM D4212. If the coating composition contains solvent (whether organic or water), the solvent evaporates in forming a coating layer on the golf ball.

The coating is cured by exposure to visible light of a wavelength that is absorbed by the photoinitiator and results in the production of free radicals. The intensity of the light at the absorbed wavelength is preferably at least about 500 mW/cm², more typically between about 750 mW/cm² and about 3000 mW/cm². Higher and lower visible light intensities may be used to cure the coating layer to a desired extent. The golf ball or other article of sports equipment may pass by the source of visible light at a distance of about 0.5 inches (12.7 mm) to about 1.75 inches (44.45 mm) and may be exposed to visible light radiation generally for about 0.5 second to 5 minutes. Care must be taken that all areas of the article on which the coating is applied are exposed to the visible light, particularly when the article is to be packaged or used shortly thereafter.

In preferred embodiments, the visible light used to cure the coating is provided by one or more LED lights. In the case of a coating on a flat surface, one or more LEDs may be located so as to emit radiation directly onto the coated surface. In the case of a curved surface, such as the surface of a game ball, an array of LED lights may be located to irradiate the coated surface. For example, there may be three LED lights, one pointed directly at the equator, and one angled at each pole. In the case of a round article, such as a golf ball, the arrangement of the LEDs may also be in a parabolic reflecting fashion such that the focal point of the visible light from the parabolic reflector impinges on the golf ball as it is rotated through this light source. There may also be several parabolic reflectors that allow for the impingement of visible light on all areas the golf ball. Also, the LEDs may be fashioned in such a way that a lens is created at the end of the LED that allows for a collimated or spread beam of visible light to impinge upon the golf ball. Further, the LEDs may be arranged in an arched tunnel fashion with the golf ball passing underneath and rotating through the light generated by the LEDs. The golf ball may be held by a spindle with three, four, or more prongs. The golf ball may be perturbed or moved at least once to ensure that the points of contact between the golf ball in the spindle are also exposed to visible light, thus curing the coating at those points. For oxidizing photoinitiators, it is preferred to exclude oxygen until after the coating is cured.

Typically, the coating layer may have a thickness of from about 5 μm to about 100 μm. In various embodiments, the coating layer may be from about 5 μm or about 10 μm or about 15 μm to about 100 μm or about 75 μm or about 50 μm or about 25 μm or about 20 μm thick.

Before the coating is applied, the game ball, such as a golf ball, or other article of sports equipment may be printed with an indicium by an ink cured using a photoinitiator that absorbs in the visible light region of the electromagnetic spectrum, then the game ball or other article of sports equipment is coated with the clear visible light-curable coating as described at least in an area over the printed indicium. The ink includes a free radical-curable material that may be the same or different from the free radical-curable material of the coating, a photoinitiator that may be the same or different from the photoinitiator of the coating, and a colorant.

The free radical-curable material in the ink is selected to provide the ink with properties and characteristics, particularly adhesion (to both the surface of the article of sports equipment and interlayer adhesion with the coating), flexibility, and impact resistance, sufficient to withstand the conditions to which the printed game ball or other sports article is to be subjected. For example, the resin may be chosen to impart to the cured ink more flexibility than is inherent in an underlying substrate such as a golf ball, a golf club, or hockey stick. In this way, the indicium can flex at least as much as the substrate and is less likely to be dislodged from the substrate. The resin may have one or more functional groups that promote adhesion to the substrate and the coating, such as acid groups. Adhesion of the top coated indicium to the printed golf ball is tested by loading 10 of the printed golf balls into a porcelain jar with an equal mixture of sand and water occupying about 20% of the volume of the porcelain jar. The golf balls are tumbled in the jar for 8 hours on a ball mill, then removed and evaluated for adhesion of the indicium. At least about 50 percent, preferably at least about 70 percent, and most preferably at least about 80 percent of the surface area of the indicium, remains. An adhesion of at least about 50 percent of the indicium after this test is considered to render the surface suitable for use in competitive play.

The ink photoinitiator or photoinitiators may be the same photoinitiator or photoinitiators used in the coating composition or may be different from the photoinitiator or photoinitiators used in the coating composition. Depending on the color of the ink, the photoinitiator or photoinitiators used in the ink may have a stronger color after curing than the color of the photoinitiator or photoinitiators used in the coating composition. Nonlimiting examples of suitable Type I photoinitiators that are photochemically active in the 400 nm to 690 nm region of the electromagnetic spectrum and may be used include bisacylphosphine oxides, oxime sulfonates such as Irgacure® PAG 103, Irgacure® PAG 121, Irgacure® CGI 1380, mono- and di-benzoyl germane compounds such as those mentioned above, organoborates, and blends of diphenyl(2,4,6-trimethylbenzoyl)phosphine oxide and 2-hydroxy-2-methylpropiophenone such as the 50/50 blend by weight of diphenyl(2,4,6-trimethylbenzoyl)phosphine oxide and 2-hydroxy-2-methylpropiophenone available from BASF Corporation as Darocur® 4265. Suitable Type II photoinitiators active in the 400 nm to 690 nm region of the electromagnetic spectrum include benzophenones and benzophenone derivatives, thioxanthones (TX) and their thiol and carboxylic acid derivatives, benzil, quinones, anthraquinones, ketocoumarins, and some 1,2-diketones, for example thioxanthen-9-one, isopropylthioxanthone, camphorquinone, phenanthrenequinone, 1-phenyl-1,2-propanedione, 2-(2-chlorophenyl)-1-[2-chlorophenyl)-4,5-diphenyl-2H-imidazoyl-2-yl]-4,5-diphenyl-1H-imidazole, benzophenones such as 4,4′-bis(diethylamino)benzophenone, 4,4′-bis(dimethylamino)benzophenone, and 4-(dimethylamino)benzophenone, and 7-ethylthiochromeno[2,3-b]carbazol-13(7H)one, thioxanthone-ethylcarbazole), as well as those that have already been mentioned as suitable for use in the coating.

The ink also includes a colorant, which may be selected from pigments, dyes, and combinations of these. The ink may, for example, contain one or more pigments to provide a desired color. Suitable pigments include, without limitation, inorganic pigments such as carbon black, titanium dioxide, black iron oxide, and so on; and organic pigments such as azo pigments such as lithol reds (e.g., calcium lithol red, barium lithol red), rubine reds, and naphthol reds, oranges, and browns; monoarylide and diarylide pigments such as diarylide yellow, phthalocyanine blue and green pigments, azomethine pigments, methine pigments, anthraquinone pigments, perinone pigments, perylene pigments, diketopyrrolopyrrole pigments, thioindigo pigments, iminoisoindoline pigments, iminoisoindolinone pigments, quinacridone pigments such as quinacridone reds and violets, flavanthrone pigments, indanthrone pigments, anthrapyrimidine pigments, carbazole pigments such as carbazole violet, benzimidazolone yellows, tolyl orange, naphthol orange, and quinophthalone pigments. and so on. Examples of suitable dyes include azo dyes such as monoazo and disazo, metal complex salt dyes, naphthol dyes, anthraquinone dyes, indigo dyes, carbonium dyes, quinoneimine dyes, cyanine dyes, quinoline dyes, nitro dyes, nitroso dyes, benzoquinone dyes, naphthoquinone dyes, naphthalimide dyes, perinone dyes, phthalocyanine dyes, and triarylmethane dyes. The colorants may be used singly or in any combination.

Solid pigments are typically pre-dispersed before being incorporated into the ink, for example in liquid monomer or resin. Carbon black and iron oxide black are non-limiting examples of suitable pigments for making black inks The colorant may be included in the ink composition in amounts of generally from about 2 to about 100 parts by weight based on 100 parts by weight of the total weight of free radical-curable materials in the ink composition. The amount of colorant included in the ink depends largely on the particular pigment and the desired color strength for the ink.

The ink is formulated to have a viscosity suitable for the printing method by which it will be applied. To facilitate pad transfer, in embodiments of the disclosure, the ink composition has a viscosity of between about 50 centipoise and about 15,000 centipoise, typically between about 100 centipoise and about 10,000 centipoise, and more typically between about 500 centipoise and about 3,000 centipoise at the time of application, with the viscosity being determined using a Brookfield viscometer model RVT equipped with a #2 spindle at 30 rpm with the sample at 25° C. (standard temperature and pressure conditions).

Typically, free radical-curable monomer is used to adjust viscosity, but organic solvent such as toluene, xylene, methyl ethyl ketone, butyl acetate, and so on or water (in the case of water-soluble or water-dispersible free-radical curable material) may also be used. In embodiments in which a solvent is used, the solvent typically is a liquid with a fast to moderate evaporation rate so that the ink composition becomes tacky fairly quickly to promote transfer from the ink pad onto the substrate being printed. When solvent is used, the photoinitiator may be introduced into the ink composition as a solution in an organic solvent. When solvent is used, the ink composition typically includes about 1 wt percent to about 30 wt percent solvent, more typically about 5 wt percent to about 20 wt percent solvent, and most typically about 8 wt percent to about 10 wt percent solvent, based on the weight of the ink composition. More or less solvent may be needed depending on the oil absorption characteristics of the pigments.

The ink may contain any desired additives known in the art. Illustrative examples of additives include, without limitation, surfactants, wetting agents, waxes, emulsifying agents and dispersing agents, antioxidants, flow agents and other rheology modifiers, and anti-settling agents. The surface tension of the ink composition affects pad transfer. The surface tension of the ink composition should not be substantially higher than the surface tension of the substrate upon which it is printed. In selected embodiments, wetting agents can be added if necessary to prevent beading of the ink composition upon application to the substrate, such as upon the surface of a golf ball. Suitable wetting agents include, but are not limited to, silicon surfactants and fluorocarbon surfactants. The ink composition typically includes up to about 2 wt percent wetting agent, based on the weight of the ink composition. Other additives that do not adversely affect the pad transfer and impact resistance of the ink composition also can be incorporated into the ink composition. When included, additives are typically included in amounts of from about 0.001% to about 7% by weight of the ink composition.

The ink may be applied by pad printing as an indicium to a substrate, such as a game ball and in particular a golf ball. Other printing methods, such as screen printing, gravure printing, or ink jet printing, can be used to apply the ink to a surface of an article of sports equipment. The ink composition and its viscosity are adjusted to suit the application method.

The ink composition can be used for printing indicia on various substrates, such as game balls, such as golf balls, softballs, baseballs, and other game balls. Other sports-related substrates include, but are not limited to, bats such as a baseball or cricket bat, and sticks such as field hockey sticks and lacrosse sticks. The ink composition also can be used on substrates formed from ionomeric addition polymers, polybutadiene, synthetic leathers based on polyurethane or polyvinyl chloride, and other substrates.

The viscosity of the ink composition affects the thickness of the indicium on the cover. The indicium has a thickness of less than about 100 micrometers, typically about 10 micrometers to about 40 micrometers, more typically about 13 micrometers to about 30 micrometers, and most typically about 20 micrometers to about 25 micrometers.

The applied ink is at least partially cured by exposure to visible light at a wavelength that is absorbed by the photoinitiator to cure the indicium to at least an extent that that clear top coat can be applied over it without disturbing the indicium. The visible light is preferably provided by one or more LED lights that emit visible light having a wavelength absorbed by the photoinitiator. In some embodiments of the disclosure, the pad to be used for transfer of the ink composition typically contains silicone. This type of pad has good elasticity, durability, and softness and an appropriate surface tension. Other types of pads also can be used.

The step of curing with visible light typically may include placing the indicium under a visible light LED at conditions of lamp intensity, light wavelength, lamp distance, and time sufficient to cure of the ink to a desired extent. The light can be directed at the surface of the ball directly or by way of a suitable reflector, such as a parabolic reflector, which can be used to intensify the light on the indicium. The LED is selected to emit light at least at a particular wavelength or wavelength at which the photoinitiator absorbs light in the visible region of the electromagnetic spectrum, the ink may be cured in general under the same conditions described above for curing the coating. In various embodiments, cured ink may have a Sward hardness (ASTM D 2134-66) of no more than about 40 when fully cured.

The ink may be only partially cured before the golf ball is coated with the clear coating, then fully cured at the same time that the coating is cured. This may be beneficial for many reasons, including reducing the overall process time for printing and coating the ball, reducing the energy used in the process, and increasing the intercoat adhesion between the printed indicium and the clear top coat layer. In one embodiment, the ink and the coating contain the same photoinitiator used in curing the applied coating layer so that the ink is cured further when the coating is cured by exposure to visible light at a wavelength that is absorbed by the photoinitiator to generate free radicals the initiate polymerization of the free radical-curable material in the coating. In another embodiment, the ink contains an initiator that is different from the initiator in the coating but that absorbs visible light at a wavelength that is in the visible light emitted by the light source used to cure the coating so that the ink is cured further when the coating is cured. In still another embodiment, the ink contains an initiator that is different from the initiator in the coating and two light sources are used during curing of the coating, one that emits visible light at a wavelength that is absorbed by the coating's photoinitiator to generate free radicals and cure the coating and a second light source that emits visible light at a wavelength that is absorbed by the ink's photoinitiator to generate free radicals and further cure the ink.

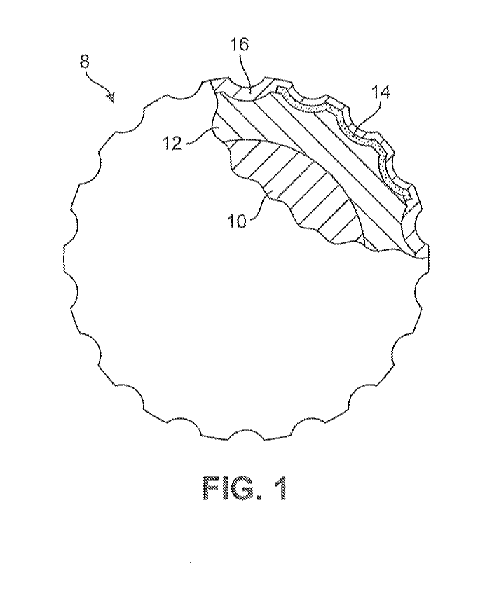

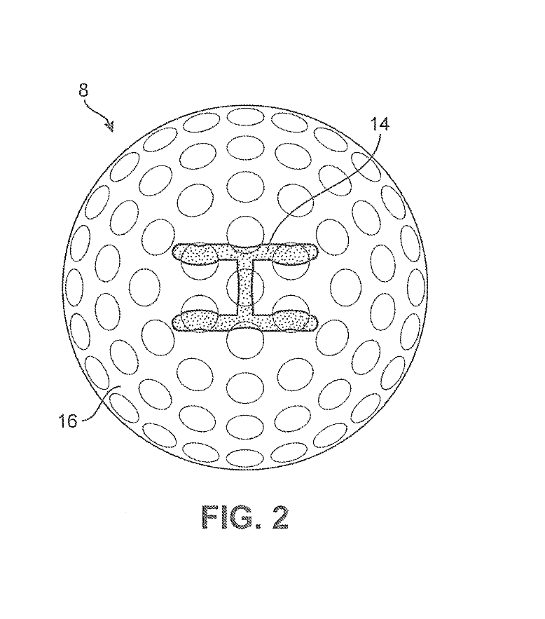

FIG. 1 illustrates a golf ball 8 having indicium 14 on the surface of the cover layer covered with clear top coat layer 16. Ball 8 in FIG. 1 includes, for example, a core 10, and a durable cover layer 12 having a dimpled surface. Alternatively, the core and cover can be formed in one piece. FIG. 2 is a perspective view of the golf ball 8 having indicium 14 on the surface of the cover layer covered with top coat layer 16.

The golf ball may have any known construction, including a one-piece ball, a two-piece golf ball with a core and a cover around the core, or a multi-layer golf ball comprising more a center, one or more intermediate layers outward from the center, and a cover as an outermost layer.

The core of the golf ball may be solid, semi-solid (e.g., paste or gel), hollow, or filled with a fluid or powder in a one-piece or multi-piece construction. As used in describing the core, a fluid may be a liquid, paste, gel, gas, or some combination of these. Nonlimiting examples of suitable core materials include thermoset elastomers, thermoplastic elastomers, and ionomers. Nonlimiting examples of elastomers include natural rubber and synthetic rubbers such as styrene butadiene rubber, polybutadiene rubber, polyisoprene rubber, styrene-butadiene rubber (SBR), and ethylene-propylene-diene terpolymer (EPDM). High cis-polybutadiene (at least 40%, preferably at least 70%, and more preferably at least 90% cis-1,4 bond) crosslinked with a diacrylate such as zinc diacrylate is one preferred rubber. Examples of thermoplastic materials include thermoplastic polyurethanes, including thermoplastic polyurethane elastomers, polyamides, polyesters, and other thermoplastic elastomers. The core may also be made of a highly-neutralized ionomer composition, particularly a metal salt of a random copolymer of an olefin, especially ethylene, and an ethylenically unsaturated acid, such as acrylic acid or methacrylic acid, optionally along with an ester of an ethylenically unsaturated acid, such as an alkyl acrylate. The ionomer resin may be neutralized to any degree. In some embodiments, the ionomer resin may be neutralized at least about 20%, or at least about 40% or at least about 70%, or at least 90%, and up to or nearly 100% with an alkali or alkaline earth metal such as sodium or magnesium. The ionomer resin composition may further include a metal salted C1-C36 monocarboxylic acid. Suitable ionomer resins are disclosed, for example in U.S. Pat. Nos. 5,179,168, 5,580,927, 6,100,321; 6,777,472; 6,653,383; 6,815,480; 6,953,820; and 7,375,151, all assigned to DuPont, all of which are incorporated herein by reference.

The golf ball may have a multi-layer core where the innermost core section and each succeeding layer extending outwardly from it is prepared from one of the materials already mentioned as useful for the core or from other materials, a wound layer formed with tensioned thread material of inorganic (e.g., glass, carbon) or organic (e.g., block copolymer, polyester, crosslinked cis-polyisoprene) fibers. Each layer may include fillers such as those already mentioned or other customary additives.

The core may be surface-treated before the cover or a cover layer is applied. Nonlimiting examples of suitable surface preparations include mechanically or chemically abrasion, corona discharge, plasma treatment, or application of an adhesion promoter such as a silane.

In one embodiment, the golf ball cover may be thermoplastic or thermoset. For example, the cover or a cover layer may include a polyurethane, for example an elastomeric polyurethane prepared by reacting a mixture comprising a polyester or polyether diol, a diisocyanate, and optionally one or more low molecular weight diols. In addition to or instead of a polyurethane, the cover may include other polymers, such as polyesters or various thermoplastic elastomers, for example polyester or styrene-block copolymer thermoplastic elastomers, In other embodiments, the cover may include an ionomer resin. Examples of ionomer resin that may be used include copolymers of ethylene, an α,β-ethylenically unsaturated acid having 3 to 8 carbon atoms, and optionally an ester of an α,β-ethylenically unsaturated acid having 3 to 8 carbon atoms that are at least partially neutralized with a metal ion. Examples of the ethylenically unsaturated acid include acrylic acid, methacrylic acid, crotonic acid, fumaric acid, and maleic acid; in particular, acrylic acid and methacrylic acid may be preferred. Examples of the α,β-ethylenically unsaturated esters include the methyl, ethyl, propyl, isopropyl, butyl, isobutyl, tert-butyl, amyl, and hexyl esters of acrylic acid, methacrylic acid, crotonic acid, fumaric acid, and maleic acid; in particular, acrylates and methacrylates are useful. The neutralizing metal ion may be, for example, monovalent metal ions such as sodium, potassium, and lithium ions; divalent earth metal ions such as magnesium, calcium, zinc, and barium; and other metal ions such as aluminum, zirconium, and tin, with sodium, zinc, and magnesium ions being among those preferred.

The cover usually includes a pigment, such as those already mentioned. The cover is typically pigmented with a white pigment such as titanium dioxide or zinc oxide. Generally titanium dioxide is used as a white pigment, for example in amounts of from about 0.5 parts by weight or 1 part by weight to about 8 parts by weight or 10 parts by weight passed on 100 parts by weight of resin. In various embodiments, a white-colored cover may be tinted with a small amount of blue pigment or brightener.

The cover may also contain one or more customary additives such as fillers, dispersants, hindered amine light stabilizers such as piperidines and oxanalides, ultraviolet light absorbers such as benzotriazoles, triazines, and hindered phenols, antioxidants such as phenols, phosphites, and hydrazides, plasticizers, processing aids, surfactants, fluorescent materials and fluorescent brighteners, and so on. Examples of suitable inorganic fillers include zinc oxide, zinc sulfate, barium carbonate, barium sulfate, calcium oxide, calcium carbonate, clay, tungsten, tungsten carbide, tin oxide, zinc carbonate, silica, talc, clays, glass fibers, and natural fibrous minerals. Suitable organic fillers may include melamine colophony, cellulose fibers, polyamide fibers, polyacrylonitrile fibers, polyurethane fibers, or polyester fibers. Polymeric, ceramic, metal, and glass microspheres also may be used. Combinations of any of these may be used. Fillers may be used to adjust the specific gravity, modulus, and other physical properties of the cover. The total amount of the filler may be from about 0.5 to about 30 percent by weight of the polymer components. Wetting or dispersing additives may be used to more effectively disperse the pigments and particulate fillers. Generally, the additives will be present in the cover in an amount between about 1 and about 70 weight percent based on the total weight of the composition depending upon the desired properties.

Golf balls may be formed using a variety of techniques such as compression molding, thermoforming, injection molding including retractable pin injection molding, reaction injection molding (RIM), and liquid injection molding (LIM), casting, vacuum forming, powder coating, flow coating, spin coating, dipping, spraying, and so on depending on the materials used for a specific component. For example, casting, RIM, or LIM may be preferred when the material is thermoset, whereas compression molding or injection molding may be preferred for liquid compositions or thermoplastic precursors. An of these methods may be used in preparing a core (unitary or with outer layers), which may be covered with a dimpled cover layer formed by injection molding, compression molding, casting, vacuum forming, powder coating, injection molding, and so on. For example, when the cover is formed by injection molding, a core fabricated beforehand may be set inside a mold, and the cover material may be injected into the mold. Reaction injection molding may be used to provide a thermoset cover. Alternatively, another method that may be used involves pre-molding a pair of half-covers from the cover material by die casting or another molding method, enclosing the core in the half-covers, and compression-molding at, for example, between 120° C. and 170° C. for a period of 1 to 5 minutes to attach the cover halves around the core. In another method, the cover composition may be cast about the core. The cast cover is preferably cured in a closed mold. The casting process may be performed under nitrogen. A first half of the cover may be formed in a mold over the core, then a second half of the cover assembled to the first half and cured to form a finished cover. The surface of the core may be surface-treated before the cover is formed over it to increase the adhesion between the core and the cover. The cover typically has a dimple pattern and profile to provide desirable aerodynamic characteristics to the golf ball.

The golf ball can be manufactured so as to conform with the Rules of Golf for competitive play with a ball diameter which is of a size that will not pass through a ring having an inside diameter of 42.672 mm, but is not more than 42.80 mm, and to a weight of generally from 45.0 to 45.93 g.

The coating may applied on other sports balls or on other sporting goods, such as golf clubs.

The following example illustrates some features of this disclosed technology.

### Example

A golf ball printing ink composition is prepared with:

| Material | Quantity, parts by weight |
|---|---|
| CN965A80¹ | 100 |
| IRGACURE ® 819² | 10 |
| Red dispersion³ | 20 |
| Solvent Naphtha | 50 |

¹An aliphatic polyester-based urethane diacrylate oligomer in tripropylene glycol diacrylate, available from Sartomer USA, LLC (Exton, PA).
²Bis(2,4,6-trimethylbenzoyl)-phenylphosphine oxide, available from BASF Corporation (Wyandotte, MI).
³A dispersion of 65 parts by weight of SICO ® Fast Red L 3855 in 35 parts by weight tripropyleneglycol diacrylate.

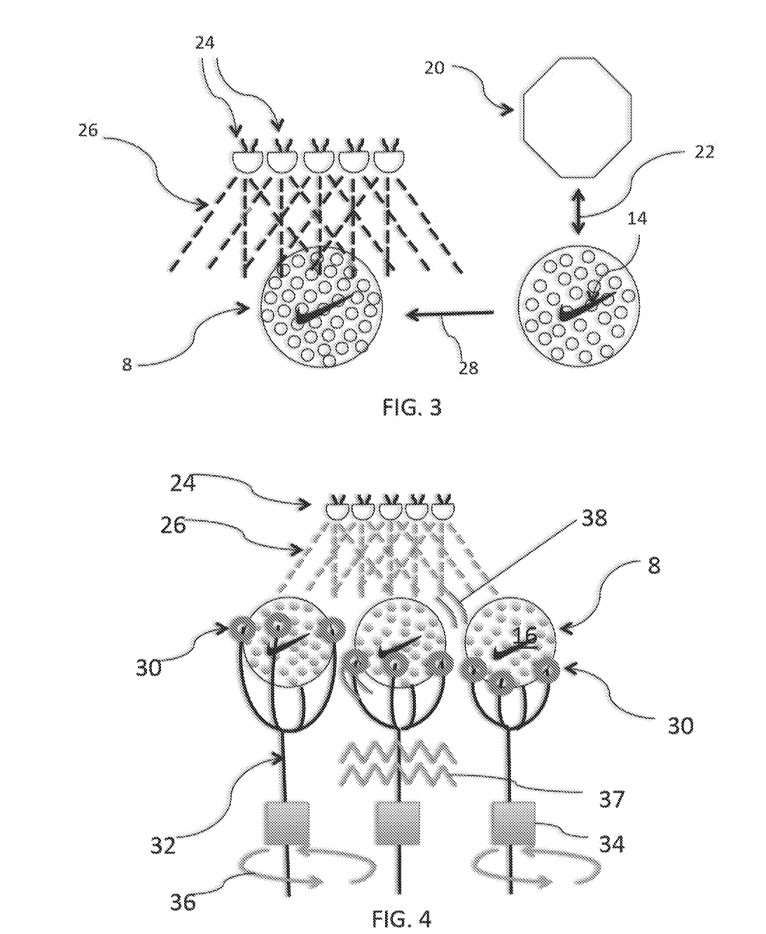

The components are blended together to form the ink composition. As illustrated by FIG. 3, transfer stamp 20 is used to transfer the ink composition in a design 14 to unprimed cover of a golf ball 8. Arrow 22 indicates that after transferring the ink, transfer stamp can be re-inked to print a design on a next ball.

The golf ball 8 with the stamped indicium 14 is moved to a position to be cured with LED lights 24 that emit visible light 26. The type of LED light used to cure the ink is Model LEDEngin: LZ110UA00-U8, with a custom heat sink and power supply, using a power dissipation of 5 Watts and a luminous flux of 550 mW. Another suitable LED light is Lumex QuasarBrite, model SSL-LXT046UV2C (chip material InGaN, peak wavelength 405 nm, typical intensity 6.0 The wavelength of the light is centered at 405 nm. The indicium is exposed to light radiation 26 from the LED lights 24 for about one minute. Then the ball is coated with a coating composition prepared with:

| Material | Quantity, parts by weight |
|---|---|
| CN2920¹ | 100 |
| Isobornyl acrylate | 20 |
| Tripropylene diacrylate | 10 |
| IRGACURE ® 184² | 2.0 |
| IRGACURE ® 819³ | 05.0 |

¹An aliphatic urethane acrylate oligomer available from Sartomer USA, LLC (Exton, PA).
²1-hydroxycyclohexylphenyl ketone, available from BASF Corporation (Wyandotte, MI).
³Bis(2,4,6-trimethylbenzoyl)-phenylphosphine oxide, available from BASF Corporation (Wyandotte, MI).

The components are mixed, then reduced with methyl amyl ketone to a spray viscosity of 18 seconds Zahn #2 cup as measured at 25° C. The reduced coating composition is applied with a spray gun onto the surface of the golf ball, then cured with LED lights mounted in a parabolic reflecting fashion such that the focal point of the visible light from the parabolic reflector impinges on the golf ball as it is rotated through this light source. There may also be several parabolic reflectors that allow for the impingement of visible light on the golf ball. Also, the LEDs may be fashioned in such a way that the lens is created at the end of the LED that allows for a collimated or spread beam of visible light to impinge upon the golf ball. The LEDs may be arranged in an arched tunnel fashion with the golf ball passing underneath and rotating through the light generated by the LEDs.

FIG. 4 illustrates an arrangement in which the coated golf ball 8 may be held by a pronged spindle 32 with three or four or more prongs under LED lights 24 as it is cured with light energy 26 from the LED lights 24. While the ends of the spindle 32 prongs are small, they cover some are of the coating at points 30. The golf ball 8 is perturbed at least once, as shown by motion indicators 37 and 38, by a vibrator or shaker 34 moving spindle 32 in a back-and-forth or rotating pattern 36 to ensure that the points of contact 30 between the golf ball in the spindle are exposed to visible light to cure the coating.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An article of sports equipment comprising a clear coating, prepared by:
providing an article of sports equipment;
applying onto the article of sports equipment a clear coating comprising a free radical-curable material and a photoinitiator that absorbs light in the visible light region of the electromagnetic spectrum to generate free radicals;
curing the applied clear coating with radiation at one or more visible light wavelengths absorbed by the photoinitiator.

2. An article of sports equipment according to claim 1, wherein the photoinitiator has little or no color in the cured film or the photoinitiator oxidizes to an oxidation state that is colorless or has a less intense color compared to the photoinitator color before the coating is cured.

3. An article of sports equipment according to claim 1, wherein the photoinitiator is a member selected from the group consisting of bis(2,4,6-trimethylbenzoyl)phenylphosphine oxide, mono- and di-benzoyl germane compounds such as benzoyltrimethylgermane, dibenzoyldiethylgermane and bis-germyl ketones, (η5-2,4-cyclopentadien-1-yl)bis[2,6-difluoro-3-(1H-pyrrol-1-yl)phenyl]titanium, 5,7-diiodo-3-butoxy-6-fluorone, 2,4,5,7-tetraiodo-3-hydroxy-6-fluorone, 2,4,5,7-tetraiodo-3-hydroxy-9-cyano-6-fluorone, and combinations thereof.

4. An article of sports equipment according to claim 1, wherein the photoinitiator consisting of a member selected from the group consisting of Type II photoinitiator compounds and further wherein the abstractable hydrogen is provided by an ethylenically unsaturated monomer.

5. An article of sports equipment according to claim 4, wherein the ethylenically unsaturated monomer comprises an allyl monomer.

6. An article of sports equipment according to claim 1, wherein an indicium is printed on the article of sports equipment before applying the clear coating by steps comprising:
printing an ink in the form of an indicium on the article of sports equipment, wherein the ink comprises a free radical-curable material, a colorant, and a photoinitiator that absorbs light in the visible light region of the electromagnetic spectrum to generate free radicals;
at least partially curing the printed indicium before applying the clear coating.

7. An article of sports equipment according to claim 6, wherein the ink is partially cured before applying the clear coating and is further cured while curing the applied clear coating.

8. An article of sports equipment according to claim 7, wherein the ink and the clear coating comprise the same photoinitiator.

9. An article of sports equipment according to claim 1, wherein the article of sports equipment is a golf ball.

10. An article of sports equipment according to claim 1, wherein the clear coating comprises an aliphatic urethane acrylate.

11. A method of coating an article of sports equipment comprising
providing an article of sports equipment;
applying onto the article of sports equipment a clear coating including a free radical-curable material and a photoinitiator that absorbs light in the visible light region of the electromagnetic spectrum to generate free radicals;
curing the applied clear coating with radiation at one or more visible light wavelengths absorbed by the photoinitiator, wherein the coating is cured using one or more LED lights that emit visible light having a wavelength absorbed by the photoinitiator.

12. A method according to claim 11, wherein the coating is cured using an array of LED lights.

13. A method according to claim 12, wherein the article of sports equipment is a golf ball and further wherein the array of LED lights are arranged in a parabolic reflector such that a focal point of visible light from the parabolic reflector impinges on the golf ball as the golf ball is rotated through the array or arranged in an arched tunnel through which the golf ball rotates while passing.

14. A method according to claim 11, wherein an indicium is printed on the article of sports equipment before applying the clear coating by a steps comprising:
printing an ink in the form of an indicium on the article of sports equipment, wherein the ink comprises a free radical-curable material, a colorant, and a photoinitiator that absorbs light in the visible light region of the electromagnetic spectrum to generate free radicals;
partially curing the printed ink before applying the clear coating; and
further curing the printed ink while curing the applied clear coating.

15. A method according to claim 14, wherein the ink and the clear coating comprise the same photoinitiator.

16. A method according to claim 14, wherein the ink and the clear coating comprise different photoinitiators that each absorb light at a wavelength that is in the visible light emitted by the LED light or lights used to cure the coating so that the ink is cured further when the coating is cured.

17. A method according to claim 14, wherein the ink and the clear coating comprise different photoinitiators and wherein at least two kinds of LEDs are used during curing the coating, one kind that emits light at a wavelength absorbed by a photoinitiator in the ink and one kind that emits light absorbed by a photoinitiator in the coating.

18. A method according to claim 11, wherein the photoinitiator in the coating is oxidized after the coating is cured to a lower-color or colorless oxidation state.

19. An method according to claim 11, wherein the article of sports equipment is a golf ball.
